(19) United States
(12) Patent Application Publication
(10) Pub. No.: US 2022/0172335 A1
(43) Pub. Date: Jun. 2, 2022

(54) Machine Vision Based Inspection

(71) Applicant: International Electronic Machines Corp., Troy, NY (US)

(72) Inventors: Zahid F. Mian, Loudonville, NY (US); Anand Thobbi, New Holland, PA (US); Marc R. Pearlman, Clifton Park, NY (US); Anuj R. Nadig, Troy, NY (US)

(21) Appl. No.: 17/432,702

(22) PCT Filed: Feb. 20, 2020
(86) PCT No.: PCT/US2020/019004

§ 371 Date: Aug. 20, 2021

Related U.S. Application Data
(60) Provisional application No. 62/807,981, filed on Feb. 20, 2019.

(51) Int. Cl. G06T 7/00; G01N 21/88

(52) U.S. Cl. CPC G06T 7/001; G01N 21/8806; G06T 2207/30164; G06T 2207/20081; G06T 2207/20084; G01N 21/8851

(57) ABSTRACT

A solution for inspecting one or more objects of an apparatus. An inspection component obtains an inspection outcome for an object of the apparatus based on image data of the apparatus. The inspection component can use a deep learning engine to analyze the image data and identify object image data corresponding to a region of interest for the object. A set of reference equipment images can be compared to the identified object image data to determine the inspection outcome for the object. The inspection component can further receive data regarding the apparatus, which can be used to determine a general location of the object on the apparatus and therefore a general location of the region of interest for the object in the image data. The inspection component can be configured to provide image data in order to obtain feedback from a human and/or further train the deep learning engine.

### REFERENCE TO RELATED APPLICATIONS

The current application claims the benefit of U.S. Provisional Application No. 62/807,981, filed on 20 Feb. 2019, which is hereby incorporated by reference. Aspects of the invention are related to U.S. Pat. No. 9,296,108, issued on 29 Mar. 2016, which is hereby incorporated herein.

### TECHNICAL FIELD

The disclosure relates generally to machine inspections, and more particularly, to a solution for inspecting an apparatus using artificial intelligence-based machine vision.

### BACKGROUND ART

It is often desirable to automate many inspection operations currently performed by humans using an automatic machine vision inspection device. For example, the operations may be repetitive, dangerous, and/or the like. Additionally, the inspection tasks may be laborious, difficult to perform, or otherwise hard to accomplish because of human intervention. However, successful machine vision inspection automation using an automatic device requires that the machine vision device have an ability to process complex images automatically by capturing the images within the inspection environment and field condition constraints within which the machine vision device is tasked with performing the operations.

A railyard or an inspection building are illustrative examples of an environment in which is desirable to automate various operations generally performed by humans. For example, inspections of various components in the railyard are often performed by an individual, who manually inspects the various components by walking along and making subjective determinations regarding the operability of the components. In terms of the basic inspection capability, any individual capable of physically travelling along the tracks in the railyard and capturing visual inspections will have no problem performing these relatively straightforward operations. However, humans in these settings are quite expensive, e.g., costing $50/hour or more. More importantly, such operations in an environment where the rail vehicles may be moving is quite hazardous. A single misstep can cause anything from bruises to death. Humans also tire relatively easily and cannot always keep track of all events that may occur while performing what are mostly boring and repetitive tasks. Finally, inspections can be hard to carry out for dark, dimly lit objects, poor image contrast, snow, fog, etc.

### SUMMARY OF THE INVENTION

Aspects of the invention provide a solution for inspecting one or more objects of an apparatus. An inspection component obtains an inspection outcome for an object of the apparatus (e.g., pass or fail) based on image data of the apparatus. The inspection component can use a deep learning engine to analyze the image data and identify object image data corresponding to a region of interest for the object. A set of reference equipment images can be compared to the identified object image data to determine the inspection outcome for the object. The inspection component can further receive data regarding the apparatus, which can be used to determine a general location of the object on the apparatus and therefore a general location of the region of interest for the object in the image data. When required, the inspection component can obtain human feedback as part of the inspection. The inspection component can provide image data, such as the object image data, for subsequent use as a reference equipment image and/or image data, such as the image data of the apparatus and/or the object image data, for use in retraining the deep learning engine to improve the analysis.

Embodiments of the invention can provide a solution for the automated inspection of apparatuses, such as rail vehicles, with human assistance where required. The human assistance can solve the problem at hand (e.g., identify an object and/or determine whether the object passes or fails the inspection), and also can help train the solution for improved automated performance in the future. The human inspector (e.g., expert) can be located locally or remotely.

Embodiments of the invention can include a hardware implementation that enables inspection in real time. Embodiments of the hardware implementation can include one or more graphics processing units, vision processing units, tensor processing units, high speed/high bandwidth communications, etc. Embodiments can use specialized hardware, which can accelerate deep learning training and retrieval by several orders of magnitude.

Embodiments of the invention can include sensing devices that enable image data and inspected objects to be associated with a corresponding apparatus, which can enable an accurate history of the inspections of the apparatus to be maintained.

Embodiments of the invention can use a deep learning computing architecture to detect and/or classify objects in image data. Embodiments of the invention can use a deep learning computing architecture to perform the inspection on the object automatically. Deep learning refers to a subset of machine learning computing in which a deep architecture of neural networks is employed to learn data representations for prediction and classification tasks. The deep learning algorithm can be configured to segment complex images, understand images, and ask for human intervention to interpret images which are not understandable. Use of a deep learning neural network differs significantly from classic computer vision approaches which rely on engineered features. Deep learning neural networks understand an image in a manner similar to humans by breaking the image down into constituent parts such as edge, curves, etc. This analysis can enable a system to incorporate a wide variety of target equipment to the training set without the need to engineer specific features for each equipment type.

Embodiments of the invention can provide solutions for transmitting image data to a remote location, e.g., using image compression, regions of interest, and/or the like. Specialized hardware and/or software can be employed to run the compression algorithms quickly so that the system is responsive. The image data can be presented to a human for assistance in the inspection. Having the machine vision deep learning system work in cooperation with the human can provide 100% system performance, which may be required due to legal, regulatory, or economic reasons. The image data can be added to a remotely located training database, which can be used to retrain one or more deep learning algorithms.

Additionally, embodiments can feed learned images back in to the deep learning algorithm to improve the performance over time. Embodiments can implement a training regimen and training system, which results in a deep learning neural network that can be continually improved over time.

Embodiments can utilize reference equipment image data to discern an operability of an object, e.g., good equipment or bad equipment, based on previous presentations and reviews. Embodiments also can utilize stored information regarding an apparatus being inspected. Such information can include the general location of one or more objects on the apparatus to be inspected. The apparatus information can improve reliability and performance of the deep learning engine, thereby providing a higher rate of automated inspections and saving manual inspection costs.

A first aspect of the invention provides an environment for inspecting an object of an apparatus, the environment comprising: an inspection system including: an inspection component for receiving image data of the apparatus and obtaining an inspection outcome for the object of the apparatus based on the image data; and a deep learning engine configured to implement a deep learning model in order to analyze the image data and identify object image data corresponding to a region of interest for the object, wherein at least one of the inspection component or the deep learning engine determines the inspection outcome for the object using a set of reference equipment images and the object image data.

A second aspect of the invention provides an environment for inspecting an object of an apparatus, the environment comprising: an acquisition system including: a plurality of sensing devices configured to acquire data regarding an apparatus present in an inspection area; triggering logic configured to process the data regarding the apparatus to determine when to start and stop acquiring image data of the apparatus; and a set of cameras configured to acquire the image data of the apparatus in response to a signal received from the triggering logic; and an inspection system including: a data acquisition component for receiving the image data acquired by the set of cameras and data regarding the apparatus; an inspection component for receiving the image data of the apparatus and obtaining an inspection outcome for the object of the apparatus based on the image data; and a deep learning engine configured to implement a deep learning model in order to analyze the image data and identify object image data corresponding to a region of interest for the object, wherein at least one of the inspection component or the deep learning engine determines the inspection outcome for the object using a set of reference equipment images and the object image data.

A third aspect of the invention provides an environment for inspecting an object of an apparatus, the environment comprising: an inspection system including: an inspection component for receiving image data of the apparatus and obtaining an inspection outcome for the object of the apparatus based on the image data; and a deep learning engine configured to implement a deep learning model in order to analyze the image data and identify object image data corresponding to a region of interest for the object, wherein at least one of the inspection component or the deep learning engine determines the inspection outcome for the object using a set of reference equipment images and the object image data; and a training system including: a deep learning training component for training the deep learning engine; and a training database including image data for training the deep learning engine, wherein the inspection component transmits image data acquired during an inspection for storage in the training database, and wherein the deep learning training component periodically retrains a deep learning model and deploys an updated deep learning model for use in the inspection component.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows a block diagram of an illustrative implementation of an environment for inspecting apparatuses according to an embodiment.

FIG. 2 shows an illustrative rail vehicle.

FIG. 3 shows a block diagram of an illustrative environment for inspecting rail vehicles according to an embodiment.

FIG. 4 shows illustrative features of an environment for inspecting rail vehicles deployed adjacent to railroad tracks according to an embodiment.

FIGS. 5A and 5B show more detailed front and back views of an illustrative embodiment of various devices mounted on a pipe frame for track side data acquisition according to an embodiment.

FIG. 6 shows illustrative details of an image capture process according to an embodiment.

FIG. 7 shows an illustrative inspection process according to an embodiment.

FIG. 8 shows an illustrative hardware configuration for implementing deep learning in a solution described herein according to an embodiment.

It is noted that the drawings may not be to scale. The drawings are intended to depict only typical aspects of the invention, and therefore should not be considered as limiting the scope of the invention. For example, embodiments of the invention are not limited to the particular number of like elements shown in a corresponding drawing. In the drawings, like numbering represents like elements between the drawings.

### DETAILED DESCRIPTION OF THE INVENTION

The inventors propose an automatic machine vision inspection system, which can capture high quality images in complex environments, process the images using artificially intelligent (AI) algorithms, such as from the deep learning class, to address the unique challenges to recognizing small targets. Like human beings, a machine vision system described herein can “understand” what the cameras “see.” An automatic machine vision device described herein can carefully analyze a scene using various heuristics and algorithms and determine whether a given set of characteristics is present.

Unfortunately, for many potential targets, the simple target characteristics—loops, straight lines, etc.—which can be derived by a reasonable-sized computational platform in real time can result in many false positives. For example, in a typical railyard application where a human visually identifies an applied brake. Such an identification can be automated using a simple camera based device to locate a brake rod. However, the brake shoe is difficult to identify in dark image data acquired by cameras, including those from lettering or shadows, and can present a significant challenge in trying to determine, for example, brake shoe dimensions. This challenge is further exacerbated when the brake shoe is on a moving rail vehicle, such as part of a train, where the angle of view is constantly changing in three dimensions as the rail vehicle moves.

An automated machine vision device can be configured to implement more complex methods to reduce or eliminate uncertainty in analyzing the environment by using more robust image processing techniques. However, such methods require considerable computation time, which can make implementation on an affordable machine vision platform impractical or impossible. As a result, one can use a super computer to implement complex algorithms to perform machine vision algorithms but that would not be practical.

As indicated above, aspects of the invention provide a solution for inspecting one or more objects of an apparatus. An inspection component obtains an inspection outcome for an object of the apparatus based on image data of the apparatus. The inspection component can use a deep learning engine to analyze the image data and identify object image data corresponding to a region of interest for the object. A set of reference equipment images can be compared to the identified object image data to determine the inspection outcome for the object. The inspection component can further receive data regarding the apparatus, which can be used to determine a general location of the object on the apparatus and therefore a general location of the region of interest for the object in the image data. When required, the inspection component can obtain human feedback as part of the inspection. The inspection component can provide image data, such as the object image data, for subsequent use as a reference equipment image and/or image data, such as the image data of the apparatus and/or the object image data, for use in retraining the deep learning engine to improve the analysis.

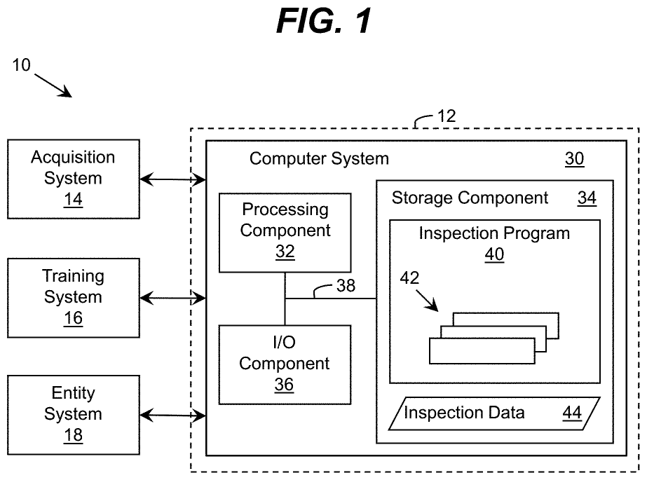

FIG. 1 shows a block diagram of an illustrative implementation of an environment 10 for inspecting apparatuses according to an embodiment. In this case, the environment 10 includes an inspection system 12, which includes a computer system 30 that can perform a process described herein in order to inspect apparatuses. In particular, the computer system 30 is shown including an inspection program 40, which makes the computer system 30 operable to inspect the apparatuses by performing a process described herein.

The computer system 30 is shown including a processing component 32 (e.g., one or more processors), a storage component 34 (e.g., a storage hierarchy), an input/output (I/O) component 36 (e.g., one or more I/O interfaces and/or devices), and a communications pathway 38. In general, the processing component 32 executes program code, such as the inspection program 40, which is at least partially fixed in storage component 34. While executing program code, the processing component 32 can process data, which can result in reading and/or writing transformed data from/to the storage component 34 and/or the I/O component 36 for further processing. The pathway 38 provides a communications link between each of the components in the computer system 30. The I/O component 36 can comprise one or more human I/O devices, which enable a human user to interact with the computer system 30 and/or one or more communications devices to enable a system user to communicate with the computer system 30 using any type of communications link. To this extent, the inspection program 40 can manage a set of interfaces (e.g., graphical user interface(s), application program interface, and/or the like) that enable human and/or system users to interact with the inspection program 40. Furthermore, the inspection program 40 can manage (e.g., store, retrieve, create, manipulate, organize, present, etc.) the data, such as the inspection data 44, using any solution.

In any event, the computer system 30 can comprise one or more general purpose computing articles of manufacture (e.g., computing devices) capable of executing program code, such as the inspection program 40, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the inspection program 40 can be embodied as any combination of system software and/or application software.

Furthermore, the inspection program 40 can be implemented using a set of modules 42. In this case, a module 42 can enable the computer system 30 to perform a set of tasks used by the inspection program 40, and can be separately developed and/or implemented apart from other portions of the inspection program 40. As used herein, the term “component” means any configuration of hardware, with or without software, which implements the functionality described in conjunction therewith using any solution, while the term “module” means program code that enables a computer system 30 to implement the actions described in conjunction therewith using any solution. When fixed in a storage component 34 of a computer system 30 that includes a processing component 32, a module 42 is a substantial portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 30.

When the computer system 30 comprises multiple computing devices, each computing device can have only a portion of the inspection program 40 fixed thereon (e.g., one or more modules 42). However, it is understood that the computer system 30 and the inspection program 40 are only representative of various possible equivalent computer systems that may perform a process described herein. To this extent, in other embodiments, the functionality provided by the computer system 30 and the inspection program 40 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 30 includes multiple computing devices, the computing devices can communicate over any type of communications link. Furthermore, while performing a process described herein, the computer system 30 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

As described herein, the inspection system 12 receives data from an acquisition system 14, which can comprise a set of I/O devices operated by the acquisition system 14 to acquire inspection data 44 corresponding to an apparatus to be inspected. The inspection system 12 can process the inspection data 44 to identify image data corresponding to one or more objects of the apparatus relating to the inspection and evaluate an operating condition of the object(s) and corresponding apparatus. When unable to identify image data corresponding to an object and/or an operability of an apparatus, the inspection system 12 can provide inspection data for use by a training system 16, which can assist with the inspection and/or training of the inspection system 12.

A result of the inspection can be provided for use by an entity system 18 for managing operation of the apparatus. In an embodiment, the result can be provided in conjunction with the apparatus. For example, multiple objects of the apparatus can be inspected. When the inspection outcome for each object indicates that the object remains safely operable (e.g., the object passes), a result of the inspection can indicate that the apparatus remains operable (e.g., passed). However, when the inspection outcome for one or more of the objects indicates that the object is not safely operable (e.g., the object fails), the result can indicate that the apparatus is not safely operable (e.g., failed) and indicate the object(s) that caused the result. The entity system 18 can track the inspection history for an apparatus and the objects thereof over time, which can allow for accurate record-keeping of the inspection history, which is currently prone to human error.

In an embodiment, the apparatus comprises a transportation apparatus, such as a vehicle. In a more particular embodiment, the vehicle is a rail vehicle. To this extent, additional aspects of the invention are shown and described in conjunction with a solution for inspecting equipment (e.g., one or more components or objects) of a rail vehicle. The rail vehicle can be included in a consist or a train, which can be moving along railroad tracks. In this case, the solution can inspect various equipment on each of the rail vehicles as they are present in and move through an area in which the acquisition system 14 can acquire data. However, it is understood that aspects of the invention can be applied to the inspection of various types of non-rail vehicles including motor vehicles, watercraft, aircraft, etc. Furthermore, it is understood that aspects of the invention can be applied to the inspection of other types of non-vehicle apparatuses, such as robotics, factory machines, etc.

The inspection of various apparatuses, such as rail vehicles, can present additional challenges that are difficult to overcome with current machine vision based approaches. For example, the rail industry does not include standardization with respect to the location of equipment or style of equipment on the rail vehicles. To this extent, there are numerous types of rail vehicles in operation and any standardization can vary by country. For freight, the rail vehicles include box cars, tanker cars, gondola cars, hopper cars, flat cars, locomotives, etc. For transit, there are many rail vehicle manufacturers who use different designs. As a result, the same type of equipment can be located at different places on the rail vehicle. An embodiment of the inspection system can be configured to capture and utilize location information.

Additionally, depending upon the manufacturer and/or the date of manufacture, the equipment being inspected may visually look different, but perform the same function. Wear and corrosion also can affect the visual features of equipment, which can change the appearance without affecting the functionality or can eventually indicate equipment requiring refurbishing or replacement. Still further, end users can modify a rail vehicle to suit one or more of their requirements. An embodiment of the inspection system can be configured to generalize various features well and successfully deal with large variations in visual features.

Additionally, to perform wayside inspection of a rail vehicle, the system is commonly installed in an outdoor environment. To this extent, the system is susceptible to weather changes and other lighting changes, e.g., due to changes in the position of the sun at different times of the day and throughout the year, sunrise, sunset, night operations, etc. Furthermore, snow, rain, and fog can typically cause a deterioration in the image quality. Due to the nature of railroads, dust and grease build up can occur causing images to appear noisy. While good illumination can overcome many of these issues, an embodiment of the inspection system can be robust against such noise.

An embodiment of the invention uses a deep learning architecture for object detection and/or classification. Use of the deep learning architecture can provide one or more advantages over other approaches. For example, as deep learning makes no assumptions regarding the features of an object and discovers the best features to use from a given training dataset, a deep learning solution is more readily scalable as there is no need to engineer features for each and every type of equipment to be inspected. A deep learning solution also can provide a mechanism to transfer learned information across so that adding new equipment to inspect is easier. A deep learning solution provides a more natural way to capture the intent, e.g., ‘find the ladder’ rather than engineering specific features for a ladder.

A deep learning solution also can provide faster performance for object detection as compared to object detection using a traditional approach, such as the sliding window approach. By incorporating vehicle representations as described herein, the deep learning system can be further improved by using hints to locate the regions in the image data to look for the equipment. Use of reference images of equipment in various operable states (e.g., good, bad, etc.) can further assist the inspection analysis and corresponding accuracy of the inspection outcome over time, particularly when a captive fleet of cars is continually being evaluated. Periodic retraining and/or updating of the reference images can allow the deep learning solution to more readily account for the wear/change in equipment over a period of time in the analysis. When the reference images include images of the same object taken over a time, the reference images can be used to identify progressive deterioration of the object when the wear is gradual. An ability to identify such deterioration can be useful in understanding the mode of failure for the particular object or type of object. Additionally, data from failures of equipment can provide insight into a quality of the equipment as provided by a particular vendor/manufacturer of the equipment under test. This insight can be used to make valuable decisions such as selection of vendors for the equipment which may provide significant financial benefits.

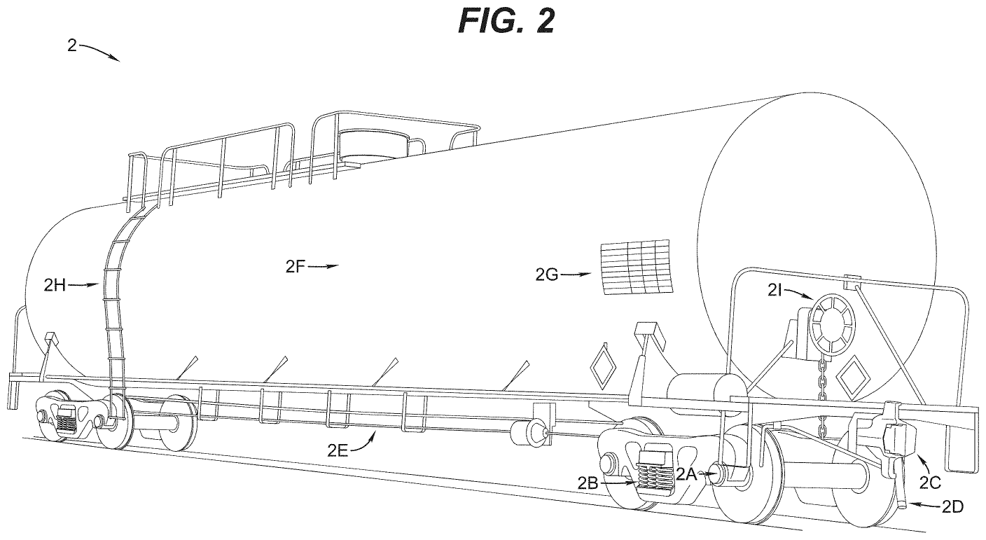

To this extent, FIG. 2 shows an illustrative rail vehicle 2, which is typical of rail vehicles requiring inspection. Various objects of the rail vehicle 2 may need to be inspected at specified time intervals, e.g., as defined by regulations issued by a regulatory body, such as the Federal Railroad Association (FRA) in the United States. Some of the objects requiring inspection include: wheel components 2A, e.g., attributes of the wheel (e.g., profile, diameter, flaws on the wheel tread and/or rim surfaces, etc.) and/or components of the axle (e.g., bearing caps, bolts, bearing condition, etc.); truck components 2B (e.g., spring boxes, wedges, side frame, fasteners, sand hose position, brake pads (shoe mounted or disc brakes), missing bolts/nuts, etc.); car coupler 2C (e.g., coupler retainer pins, bolts, cotter keys, cross keys, etc.); air hose 2D (e.g., position, other low hanging hoses, coupling, leak detection, etc.); under carriage 2E (e.g., couplers, brake rod, brake hoses, brake beam, gears and drive shafts, car center and side sills, foreign body detection, etc.); car body 2F (e.g., leaning or shifted, wall integrity, etc.); signage 2G (e.g., load limits, car identification, safety reflectors, graffiti detection, etc.); access equipment 2H (e.g., ladders, sill steps, end platforms, roof hatches, etc.); brake wheel 2I; and/or the like.

However, it is understood that the rail vehicle 2 and various objects 2A-2I described herein are only illustrative of various types of rail vehicles and corresponding objects that can be inspected using the solution described herein. For example, for a freight application, in addition to a tanker car 2 as shown in FIG. 2, the solution described herein can be used to inspect various other types of rail vehicles including: locomotives, box cars, gondola cars, hopper cars, flat cars, etc. In transit applications, the rail vehicles may have similar components as shown in FIG. 2, but the components may be of a different type and/or located at different locations on the rail vehicles. To this extent, an inspection of a rail vehicle can include inspection of any combination of various objects described herein and/or other objects not explicitly referenced in the discussion.

Image data is particularly well suited for inspection tasks since it can be interpreted by both computers (automated inspection) and humans (manual inspection). To date, the most successful implementation of inspection tasks is to use a computer assisted inspection approach, where the computer works towards reducing the load of the human inspector. A basic premise of such an approach is that a majority of the equipment that is being inspected is good.

Traditional computer vision tasks, such as object detection and classification, rely on engineered features for creating representations of images. In an embodiment, the inspection system 12 (FIG. 1) implements a deep learning image analysis architecture for object detection and classification. In an embodiment, the deep learning image analysis architecture includes a deep learning model that defines a neural network. Computer hardware executes the deep learning model and is referred to as a deep learning engine. The deep learning image analysis architecture can remove the need to engineer features for new objects by using a convolution operation. Illustrative deep neural networks that extract features and act on them are called convolutional neural networks (CNNs). CNNs include neurons responding to restricted regions in the image. CNNs have found application in image classification and object detection tasks amongst others.

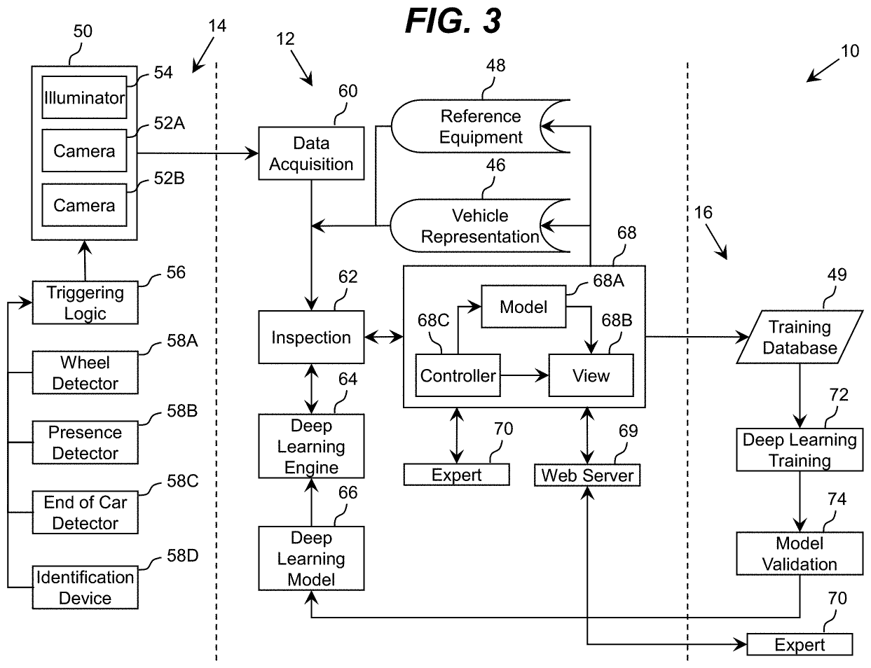

FIG. 3 shows a block diagram of an illustrative environment 10 for inspecting rail vehicles, such as the rail vehicle 2 (FIG. 2), according to an embodiment. In the diagram, the dotted lines demarcate three distinct physical locations of the corresponding blocks. For example, the acquisition system 14 can include various components (e.g., devices) that are located near and/or mounted on railroad track(s) on which the rail vehicle 2 is traveling. The components of the inspection system 12 can be located relatively close, but some distance from the railroad tracks, e.g., for safety. For example, the inspection system 12 can be located in a bungalow located some distance (e.g., at least two meters) from the railroad tracks, at a control center for a rail yard, and/or the like. The training system 16 can include components located remote from the inspection system 12, e.g., accessed via communications over a public network, such as the Internet and/or the like. To this extent, the inspection system 12 can provide functionality for data acquired by multiple acquisition systems 14, and the training system 16 can provide functionality shared among multiple inspection systems 12.

Regardless, the acquisition system 14 can include an imaging component 50, which can include a set of cameras 52A, 52B and a set of illuminators 54. The imaging component 50 can include various additional devices to keep the camera(s) 52A, 52B and illuminator(s) 54 in an operable condition. For example, the imaging component 50 can include various devices for mounting the camera(s) 52A, 52B and illuminator(s) 54 in a manner that maintains a desired field of view, a housing to prevent damage from debris, weather, etc., a heating and/or cooling mechanism to enable operation at a target temperature, a cleaning mechanism to enable periodic cleaning of the camera(s) 52A, 52B and/or illuminator(s) 54, and/or the like.

Each of the camera(s) 52A, 52B and illuminator(s) 54 can utilize any type of electromagnetic radiation, which can be selected depending on the corresponding application. In an embodiment, the imaging component 50 includes multiple cameras 52A, 52B that acquire image data using different solutions and/or for a different portion of the electromagnetic spectrum (e.g., infrared, near infrared, visible, ultraviolet, X-ray, gamma ray, and/or the like). To this extent, a camera 52A, 52B can use any solution to generate the image data including, for example, area scan or line scan CCD/CMOS cameras, infrared/thermal cameras, laser triangulation units, use of structured light for three-dimensional imaging, time of flight sensors, microphones for acoustic detection and imaging, etc. Similarly, the imaging component 50 can include illuminator(s) 54 that generate any type of radiation, sound, and/or the like, for illuminating the rail vehicles for imaging by the cameras 52A, 52B. The imaging component 50 can include one or more sensors and/or control logic, which determines whether operation of the illuminator(s) 54 is required based on ambient conditions.

Regardless, the imaging component 50 can include control logic that starts and stops operation of the camera(s) 52A, 52B and/or illuminator(s) 54 to acquire image data based on input received from triggering logic 56. The triggering logic 56 can receive input from one or more of various types of sensing devices 58A-58D, which the triggering logic 56 can process to determine when to start/stop operation of the imaging component 50.

For example, as illustrated, the sensing devices 58A-58D can include one or more wheel detectors 58A, each of which can produce a signal when a train wheel is present over the wheel detector 58A. The wheel detector 58A can be implemented as an inductive proximity sensor (e.g., eddy current induced) in a single or multiple head configuration. Use of the wheel detector 58A can help localize a train wheel very effectively, providing much needed information to the triggering logic 56 about a location of equipment being inspected. In an embodiment, the acquisition system 14 includes a plurality of wheel switches, which can provide data enabling determination regarding a speed and/or direction of travel of a rail vehicle, a separation location between adjacent rail vehicles, and/or the like.

The acquisition system 14 also can include one or more presence sensors 58B, each of which can be configured to provide information to the triggering logic 56 regarding whether or not a rail vehicle is physically present at a given location. Such information can assist the triggering logic 56 in distinguishing between when a rail vehicle has stopped over the acquisition system 14, in which case other sensors may not obtain any new information, or the last rail vehicle of a consist has left the area. In an embodiment, a presence sensor 58B can be implemented as an inductive loop detector. In another embodiment, a presence sensor 58B can be implemented as a radar sensor.

Similarly, the acquisition system 14 can include one or more end of car detectors 58C, each of which can provide information to the triggering logic 56 regarding the start/stop of a rail vehicle. The triggering logic 56 can use the information to segment individual rail vehicles in a consist to enable an inspection algorithm to include identification of the corresponding rail vehicle and wheel. In an embodiment, an end of car detector 58C can be implemented as a radar sensor.

The triggering logic 56 can receive and forward additional information regarding a rail vehicle. For example, the acquisition system 14 can include one or more identification devices 58D, which can acquire information regarding a rail vehicle that uniquely identifies the rail vehicle in a railroad operation. In an embodiment, an identification device 58D can comprise a radio frequency identification (RFID) device, which can read information from an automatic equipment identification (AEI) tag or the like mounted on the rail vehicle. In another embodiment, an identification device 58D can comprise an optical character recognition (OCR) device, which can read and identify identification markings for the rail vehicle.

The triggering logic 56 can use the data received from the sensing devices 58A-58D to operate the imaging component 50. As part of operating the imaging component 50, the triggering logic 56 can provide rail vehicle data to the imaging component 50 for association with the image data. The rail vehicle data can include, for example, data identifying the rail vehicle being imaged (e.g., using a unique identifier for the rail vehicle, a location of the rail vehicle in the consist, etc.), data identifying an object of the rail vehicle being imaged (e.g., which rail wheel, truck, etc.), and/or the like. Additionally, the rail vehicle data can include data regarding a speed at which the rail vehicle is traveling, an amount of time the rail vehicle was stopped during the imaging, start and stop times for the imaging, etc. The imaging component 50 can include the rail vehicle data with the image data acquired by the camera(s) 52A, 52B for processing by the inspection system 12.

In an embodiment, the inspection system 12 can include a data acquisition component 60, which receives the inspection data 44 (FIG. 1) from the imaging component 50. In particular, the data acquisition component 60 can be configured to receive and aggregate the image data acquired by the camera(s) 52A, 52B and rail vehicle data from the imaging component 50. In addition, the imaging component 50 can provide additional data, such as ambient lighting conditions, external temperature data, whether artificial lighting (e.g., an illuminator 54) was used, etc. In an embodiment, the data acquisition component 60 can be configured to capture image data from the camera(s) 52A, 52B, e.g., by executing a high level camera application programming interface (API), such as GigE Vision or the like. Regardless, the data acquisition component 60 can aggregate and store the data received from the acquisition system 14 as inspection data 44.

The data acquisition component 60 can provide some or all of the inspection data 44 for processing by an inspection component 62. The inspection component 62 can be configured to attempt to complete the inspection autonomously. In an embodiment, the inspection component 62 can obtain additional data, such as vehicle representation data 46 and reference equipment data 48. The vehicle representation data 46 can comprise data corresponding to different types of rail vehicles. The data can comprise information regarding the relevant equipment (e.g., one or more objects) that is present on each type of rail vehicle and an approximate location of the equipment on the rail vehicle. In an embodiment, a system designer creates the vehicle representation data 46 by conducting a survey of various types of rail vehicles to create a list of equipment present on each type of rail vehicle and the approximate location of the equipment.

It is understood that, for some applications, the vehicle representation data 46 will not be able to include data regarding an exact location of each type of object for each type of rail vehicle. For example, in the American freight railroad industry alone, there are an estimated 500,000 unique rail vehicles in operation. However, the rail vehicles can be considered based on their corresponding type (e.g., tanker cars, hopper cars, box cars, locomotives, etc.) to create equipment location information that provides a hint to restrict the search space for locating the object in image data of the rail vehicle. For example, a brake rod may be present in the center of a box car type of rail vehicle but at the end of a tanker car type of rail vehicle. During use, the vehicle representation data 46 can be updated, e.g., as a result of manual review by an expert 70, and therefore need not be a static database.

The reference equipment data 48 can include data, such as images, drawings, etc., corresponding to examples of objects in various operating states, e.g., good and bad examples of equipment. The reference equipment data 48 can further identify the particular type of rail vehicle on which the corresponding object is located to enable the most relevant reference equipment data 48 to be provided to the inspection component 62. The initial data in the reference equipment data 48 can comprise various examples of equipment at different operating conditions for the various types of rail vehicles and equipment to be inspected. Additionally, the reference equipment data 48 can include data identifying the operating condition for each example. Such data can include a binary indication of operable/not operable, a scale indicating a state of wear, and/or the like. Similar to the vehicle representation data 46, the reference equipment data 48 can be updated during use, e.g., as a result of manual review, and therefore need not be a static database.

The inspection component 62 can use a deep learning engine 64 to locate in the image data acquired for the rail vehicle some or all of the object(s) being inspected. The deep learning engine 64 can implement a deep learning model 66, which has been previously trained and validated for locating the equipment as described herein. In an embodiment, the deep learning engine 64 can segment the image and interpret features in the image to attempt to locate the object in the image. For example, the deep learning engine 64 can distinguish inspect-able objects and extract image data corresponding to those objects (or a relevant portion of an object) from an otherwise cluttered image. The deep learning engine 64 can segment objects in a given scene by vision paradigms, such as object detection or semantic segmentation. In either case, the deep learning engine 64 can be capable of generating data corresponding to one or more possible locations of the object(s) of interest in a cluttered scene. After processing the image, the deep learning engine 64 can generate possible location(s) corresponding to a region of interest for the object being inspected in the image data as well as a confidence level for the location information. The deep learning engine 64 can return the location information as, for example, a boundary in the image data.

When an object is successfully located in the image data, the inspection component 62 can attempt to complete the inspection, e.g., by determining whether the object appears to remain operable or is not operable. When the inspection cannot be successfully performed (e.g., due to an inability to identify a location of the equipment, an inability to determine the operability of the equipment, and/or the like), the inspection component 62 can request human review, e.g., by an expert 70 (who is considered as part of the training system 16). As used herein, an expert 70 is any human having sufficient knowledge and experience to reliably locate a corresponding piece of equipment in image data of a sufficient quality. Additionally, when sufficient information on the equipment is available, the expert 70 can reliably determine the operability of the equipment. It is understood that the expert 70 can be the same person or different people reviewing different images.

To this extent, the inspection component 62 can generate an interface 68 for presentation to the expert 70. The interface 68 can be presented via a local interface to an expert 70 located at the inspection system 12. Alternatively, the interface 68 can be presented to an expert 70 located some distance away, e.g., via a web server 69. In either case, the inspection component 62 can generate the interface 68 using any solution. For example, an embodiment of the interface 68 comprises a graphical user interface (GUI) that enables the expert 70 to interact with the interface 68 to, for example, view the image data for the equipment and provide information regarding its operability. In an embodiment, the inspection component 62 builds the GUI 68 using a model 68A view 68B controller 68C architecture (MVC). The MVC architecture allows for the different functions in generating the GUI to be split up modularly, thereby providing a more readily maintainable solution. In an embodiment, the inspection component 62 can present the GUI 68 as a typical .NET user interface locally, or using ASP.NET, the user interface can be presented through a web interface generated by the web server 69. However, it is understood that these are only illustrative examples of numerous solutions for generating and providing a GUI 68 for presentation to an expert 70.

In general, the GUI 68 can comprise a graphical environment for presenting text and one or more images. The text can include information regarding the object being evaluated, the corresponding rail vehicle, information regarding the inspection (e.g., where the automated inspection failed or what is being requested for review), and/or the like. The image(s) can include the image being evaluated and/or a region thereof, one or more reference equipment images being used in the evaluation, and/or the like. An embodiment of the GUI 68 can present the image being evaluated and a reference image side by side. The GUI 68 can enable the expert 70 to interact with the GUI 68 and provide feedback using any combination of various user interface controls (e.g., touch based interaction, point and click, etc.). Access to view the GUI 68 and/or an amount of interaction allowed can be restricted using any solution, e.g., one or more user login levels (e.g., administrative, general, read only, and/or the like). The GUI 68 also can enable the expert 70 to select one of multiple inspections waiting manual review (e.g., via a set of tabs) and provide feedback on the inspection, e.g., by locating a region of interest in the image and providing an indication of the operability of the object.

The expert 70 can view the GUI 68 and provide feedback regarding the corresponding object. For example, the expert 70 can indicate a region of interest in the image data corresponding to the object. Additionally, the expert 70 can provide an indication as to the operability of the object. Data corresponding to the feedback provided by the expert 70 can be used by the inspection component 62 to complete the inspection. Additionally, data corresponding to the feedback provided by the expert 70 can be stored in the vehicle representation data 46 and/or reference equipment data 48 for further use.

In an embodiment, data corresponding to the feedback provided by the expert 70 can be provided to update a training database 49 of a training system 16 for the deep learning engine 64. Initially, the training database 49 can comprise multiple example images that are used to train the deep learning engine 64. The example images and other training data can be carefully pre-processed to make the training data effective for training the deep learning models. In an embodiment, the training database 49 includes a large set of training data to properly train the deep learning engine 64. In an embodiment, the training database 49 can comprise a centralized database, which includes example images received from multiple inspection systems 12 and/or acquired by multiple acquisition systems 14. In this case, the image data and corresponding equipment information can be pooled at one place to enable the data to be used to train each of the deep learning models 66 used in the inspection systems 12. Such a solution can enable each deep learning model 66 to have a generalized understanding of the equipment utilized throughout the transportation network.

As illustrated, the training database 49 can be located remote from the inspection system 12. To this extent, uploading high resolution images in a raw format may be not be practical due to the potential for many gigabytes of data to transfer. To overcome this problem, the inspection component 62 can perform image compression on the image data to be included in the interface 68 and/or to be provided to the training database 49. In this case, the raw image can be compressed using a low-loss, low latency compression algorithm. Examples of such a compression algorithm include JPEG 2000, H.264, H.265, etc. In an embodiment, the inspection component 62 can comprise specialized image compression hardware to perform the compression.

The image data (e.g., compressed image data) can be transferred to the training database 49 along with additional information, such as a region of interest (ROI) and/or other metadata. In an embodiment, the image data and the additional information are combined and compressed using any type of lossless compression solution. The information can be transmitted using any type of format, communication network, and/or the like. For example, the information can be transmitted in an XML or JSON format through a TCP/IP network to the training database 49, where the data can be added for retraining the deep learning model 66. In an embodiment, instead of or in addition to transmitting compressed image data for inclusion in the training database 49, the inspection component 62 can transmit only the image data corresponding to regions of interest bounding the equipment for inclusion in the training database 49. In this case, an amount of data being transmitted can be reduced, thereby lowering bandwidth requirements and reducing iteration time.

As discussed herein, the inspection system 12 can use a deep learning engine 64 executing a corresponding deep learning model 66 for object identification in the image data. Use of such a solution requires training. In an embodiment, a deep learning training component 72 is located remote from the inspection system 12 and performs both initial training of the deep learning model 66 as well as periodic updates to the deep learning model 66. In an illustrative embodiment, the deep learning engine 64 is constructed using a neural network architecture, such as a convolutional neural network (CNN) architecture, a generative adversarial network (GAN) architecture, and/or the like. An embodiment of the deep learning engine 64 can include a variety of neural network architectures. In a particular example, the CNN is hierarchical, including multiple layers of neural nodes. The input to the CNN is an image. The first layers of the CNN can generate and act on smaller segments of the image to generate low-level features which look like edges. The low level features are provided to middle layers of the CNN, which combine the edges to build high level features, such as corners and shapes. The high level features are then provided to the highest layers of the CNN to perform detection and/or classification tasks.

For a deep learning model 66 to converge during training, the training database 49 requires a large set of training data. However, in an embodiment, the deep learning training component 72 can use a transfer learning approach to perform the initial model training. In this case, the deep learning training component 72 can obtain a deep learning model trained for a particular task as a starting point to train the deep learning model 66 to be used by the inspection system 12. Fine-tuning a neural network using transfer learning can provide a faster and easier approach than training a neural network from scratch. To this extent, an embodiment uses transfer learning to update the neural network more frequently and in less time than other approaches. A particular frequency and time taken are application and hardware specific. However, a transfer learning model which trains on just the final layer may run 90% faster than training the entire model.

In an embodiment, transfer learning can be used for object detection, image recognition, and/or the like. For example, transfer learning can be used when the source and target domains are different but related. The source domain is the domain in which the model was initially trained, while the target domain is the domain in which the transfer learning is applied. Often, the target and source domain are different. This constitutes most real-world image classification applications. It is also possible that the source and target labels are unavailable or too few. This type of transfer learning would constitute an unsupervised transfer learning and can be used in tasks such as clustering or dimensionality reduction which can be used for image classification.

Transfer learning can enable the deep learning model 66 to be trained using a training database 49 with a small set of labelled data. In particular, the transfer learning can leverage the use of an existing neural network model previously trained on a large training set for a large duration of time. For the CNN architecture described above, such a neural network model has learned how to effectively identify the low level features, such as edges, and the high level features, such as corners and shapes. As a result, the neural network model needs to only learn the classification and detection tasks, such as distinguishing between various objects of a rail vehicle. The deep learning training component 72 can use any of various existing deep learning models available from various deep learning software platforms, such as Inception, GoogLeNet, vgg16/vgg19, AlexNet, and others. The deep learning training component 72 can significantly reduce the training time, computing resources, and the cost of assembling an initial training database 49, required to train the deep learning model 66 through the use of transfer learning.

In an embodiment, the deep learning training component 72 to identify a relevant pre-trained CNN model, fine tune the CNN model if necessary, and replace the highest layers of the CNN that perform classification and detection tasks with new layers that are configured for performing classification and detection tasks for the inspection system 12. Subsequently, the deep learning training component 72 can train the new CNN model using the training database 49. The result is a new CNN model trained for the particular application. A model validation component 74 can test an accuracy of the new CNN model by performing regression testing where the CNN model is validated using an older data set. When the new CNN model is sufficiently accurate, the model validation component 74 can deploy the CNN model as the deep learning model 66 for use in the inspection system 12.

However, it is understood that the deep learning model 66 can be periodically retrained and updated to improve performance of the deep learning model 66, and therefore the deep learning engine 64, over time. A frequency with which the deep learning model 66 is retrained can be selected using any solution. For example, such retraining can occur after a fixed time duration, a number of inspections, a number of manual reviews, and/or the like. Additionally, such retraining can occur in response to a request from a user. Regardless, the retraining can include the deep learning training component 72 refining the deep learning model 66 using new data added to the training database 49. The model validation component 74 can run the refined deep learning model 66 on a regression dataset to validate that performance has not been lost by the retraining. If the validation succeeds, the latest deep learning model 66 can be pushed to the inspection system 12.

In an embodiment, a deep learning model 66 is expressed in the tensor flow framework as .pb (proto-buf) (json/xml alternative) and kpt (checkpoint) files. In this case, updating the deep learning model 66 at an inspection system 12 requires transferring these files to the inspection system 12. While the retraining is illustrated as being performed remote from the inspection system 12, it is understood that retraining can occur on a particular inspection system 12. Such retraining can enable the locally stored deep learning model 66 to be refined for the particular imaging conditions present at the location (e.g., background, lighting, etc.).

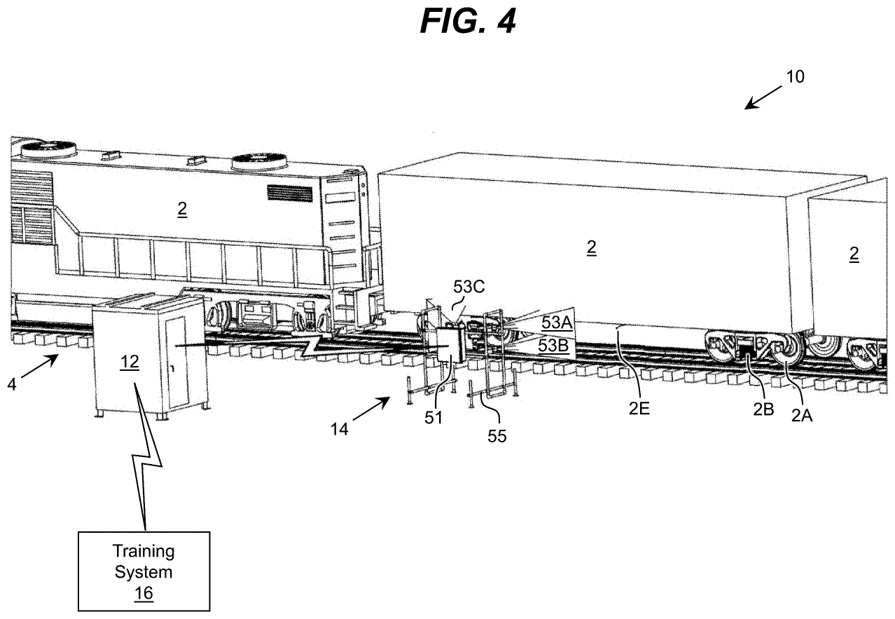

FIG. 4 shows illustrative features of an environment 10 for inspecting rail vehicles 2 deployed adjacent to railroad tracks 4 according to an embodiment. In this case, the inspection system 12 is located in a housing shown positioned relatively close to the railroad tracks 4, but sufficiently far enough away to be safe from debris that may be hanging off of the side of a rail vehicle 2 traveling on the railroad tracks 4. The inspection system 12 can communicate with an acquisition system 14, which is shown including at least some components also located near the railroad tracks 4, but some distance away. Additionally, the inspection system 12 can communicate with a training system 16, which can be located a significant distance from the inspection system 12 and is therefore shown schematically. While not shown, it is understood that the acquisition system 14 can include additional devices, which can be located in any of various locations about the railroad tracks 4 including below the tracks, above the rail vehicles, attached to a track or sleeper, etc.

As illustrated, the acquisition system 14 can include electronics 51 located within a weather proof enclosure, which provide power and signaling for operating cameras and/or illuminators of the acquisition system 14. For example, the acquisition system 14 is shown including four cameras mounted on a pipe frame 55, and which can have fields of view 53A-53C (one field of view is not clearly shown). When required, the enclosure for the electronics 51 and/or the housing for the inspection system 12 can include heating and/or cooling capabilities. The illustrated fields of view 53A-53C can enable the acquisition of image data suitable for inspecting various objects of the rail vehicles 2 moving in either direction, including the wheel components 2A, truck components 2B, car couplers, air hoses, under carriage 2E (e.g., a brake rod), etc.

Communications between the systems 12, 14, 16 can be implemented using any solution. For example, the communications link between the acquisition system 14 and the inspection system 12 can be a high speed communications link capable of carrying raw data (including image data) from the electronics 51 to the acquisition system 12 for the inspection. In an embodiment, the communications link can be implemented using a fiber optic connection. In another embodiment, the communications link can be implemented using a different communication interface, such as Wi-Fi, Ethernet, FireWire, and/or the like. The communications link between the inspection system 12 and the training system 16 can use any combination of various communications solutions, which can enable communications over the Internet with sufficient bandwidth, such as hardwired and/or wireless broadband access.

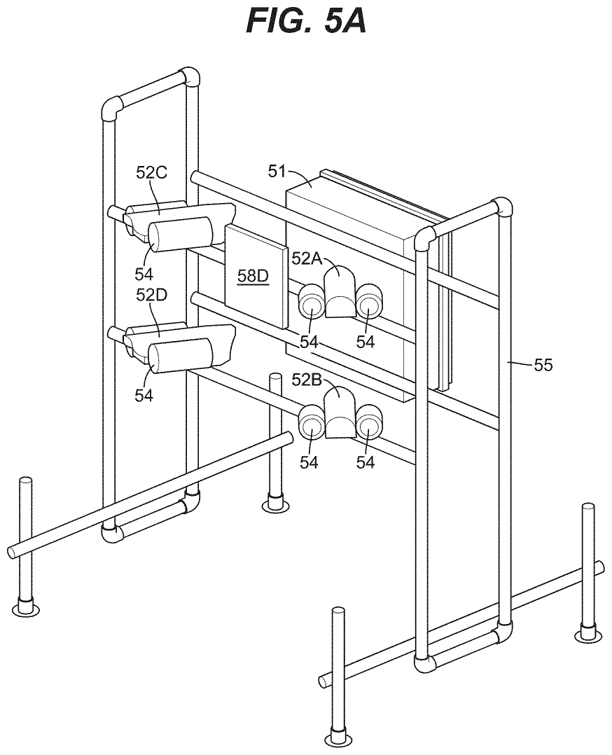

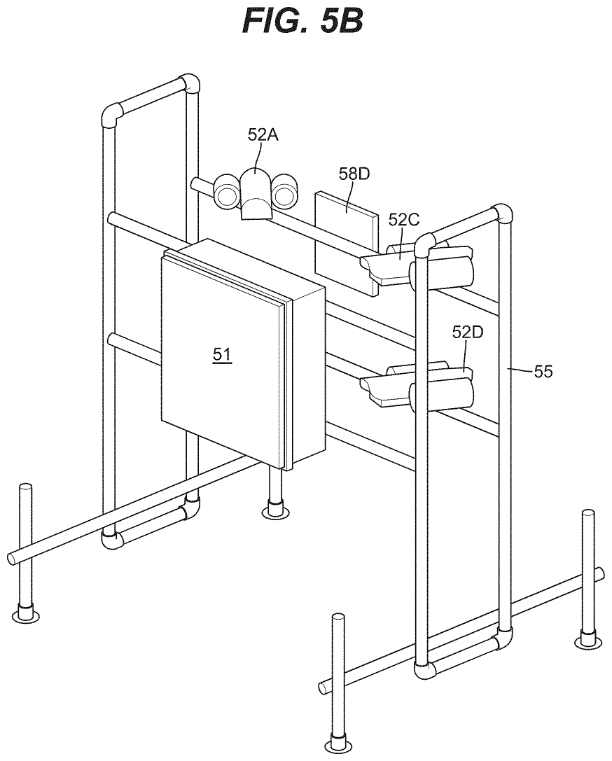

FIGS. 5A and 5B show more detailed front and back views of an illustrative embodiment of various devices mounted on a pipe frame 55 for track side data acquisition according to an embodiment. As illustrated, the pipe frame 55 can include two rows of piping on a front side to which are mounted four cameras 52A-52D, each with a pair of illuminators 54 located on either side of the camera 52A-52D. In operation, one or both pairs of cameras, such as cameras 52A-52B and/or 52C-52D, can be operated to acquire image data of rail vehicles as they are moving along the railroad tracks. When necessary, the corresponding illuminators 52 for a camera 52A-52D can be activated while the camera is acquiring image data. The cameras 52A-52D can provide the image data to the electronics 51, which can subsequently transmit the image data for processing by the inspection system. Additionally, the pipe frame 55 is illustrated with an identification device 58D, such as an RFID device, mounted thereto, which can acquire identification data for the rail vehicle being imaged by the cameras 52A-52D.

It is understood that the configuration shown in FIGS. 5A and 5B is only illustrative of various configurations that can be utilized to perform an inspection described herein. To this extent, any of various arrangements and combinations of devices can be utilized to acquire data that can be processed to inspect any combination of various objects of the rail vehicles, including objects only visible from below the rail vehicle, above the rail vehicle, from a front or back of the rail vehicle, etc. Similarly, while the illustrated configuration shows illumination from the same side as the imaging device, e.g., using illuminators colocated with the camera for imaging reflected radiation, it is understood that embodiments can include illuminating from any of various orientations, including from the opposite side of the object, e.g., for imaging based on electromagnetic radiation transmitted through the object being imaged. In each case, the particular arrangement and combination of devices utilized can be selected to provide suitable data for the inspection.

As discussed herein, the electronics 51 can comprise triggering logic 56 (FIG. 3) that manages operation of the cameras 52A-52D. Additionally, the electronics 51 can include components configured to enable communication of the image data and other data regarding a rail vehicle for processing by the inspection system 12 (FIG. 3).

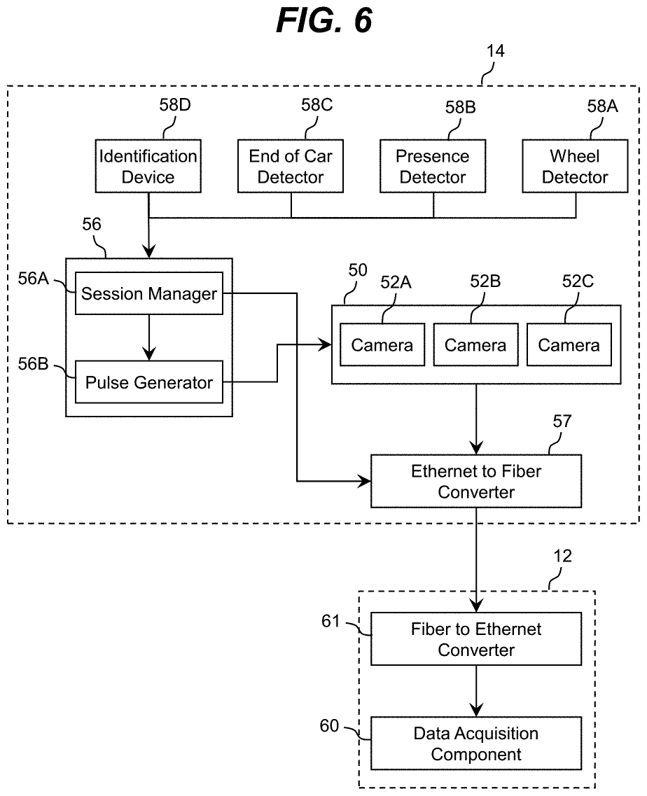

To this extent, FIG. 6 shows illustrative details of an image capture process according to an embodiment. As described herein, the triggering logic 56 can receive data from various sensing devices 58A-58D. The triggering logic 56 can include a session manager 56A, which processes the data to detect the start and stop of a consist, an individual rail vehicle, and/or the like, which is moving through or present in an imaging area. In response to detecting a rail vehicle, the session manager 56A can issue a start command for a pulse generator 56B to start operation. Upon determining that no rail vehicles are present in the imaging area, the session manager 56A can issue a stop command for the pulse generator 56B to stop operation.

While operating, the pulse generator 56B generates a series of pulses, which are configured to trigger some or all of the cameras 52A-52C of the imaging component 50 to acquire image data. In particular, the cameras 52A-52C can comprise edge/level triggers, thereby capturing an image in response to each pulse in the series of pulses. The pulses can have any suitable frequency, which enables the cameras 52A-52C to acquire image data at the corresponding frequency. Each image can be timestamped, e.g., internally by the corresponding camera 52A-52C. Additionally, the imaging component 50 can compress the images if desired. While not shown, it is understood that the triggering logic 56 can generate additional signaling, e.g., to start or stop operation of one or more illuminators 54 (FIG. 3).

Regardless, the image data generated by the cameras 52A-52C can be forwarded to the data acquisition component 60 for further processing. Additionally, the session manager 56A can provide additional data regarding the corresponding rail vehicle and/or object of the rail vehicle being imaged for use by the data acquisition component 60. The data can be provided using any type of communications link. For example, the data can be provided to an Ethernet to fiber converter 57 located in the electronics 51 (FIG. 5), which can convert Ethernet signals to fiber optic signals. At the acquisition system 12, the fiber optic signals can be received at a fiber to Ethernet converter 61, where they are converted to Ethernet signals and forwarded to the data acquisition component 60 for further processing. Use of fiber optic communications provides many benefits including, for example, high communications bandwidth, higher resiliency to noise, a longer transmission distance capability, and/or the like.

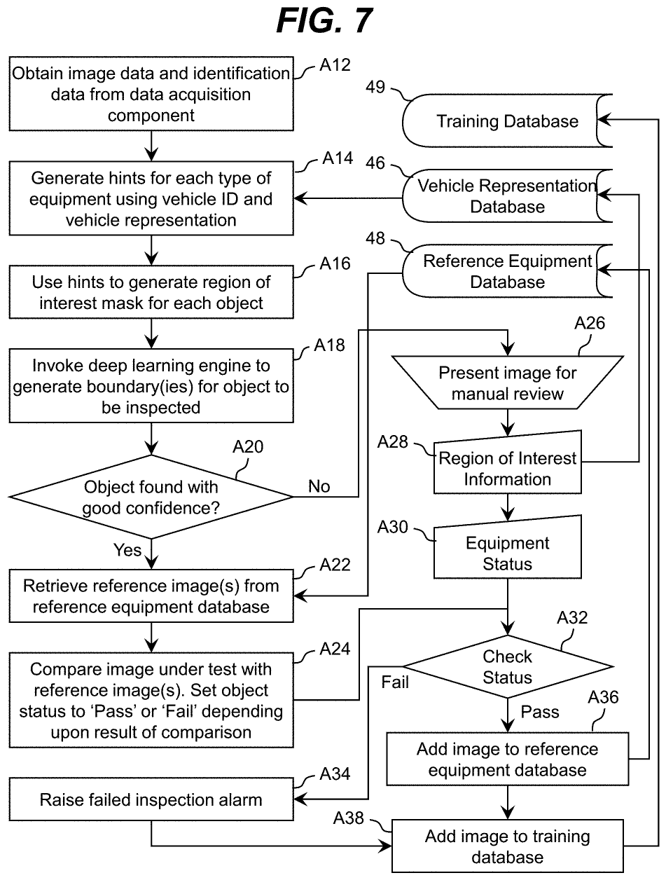

FIG. 7 shows an illustrative inspection process that can be implemented by the inspection system 12 (FIG. 3) according to an embodiment. Referring to FIGS. 3 and 7, in action A12, the inspection component 62 can obtain image data and identification data from the data acquisition component 60. In action A14, the inspection component 62 can generate hints for locating each type of equipment (object) to be inspected in the image data. For example, the inspection component 62 can use the rail vehicle identification information to retrieve the corresponding vehicle representation data 46 including data regarding the regions on the rail vehicle at which the various equipment is located to generate the hints.

In action A16, the inspection component 62 can use the hints to generate a region of interest mask in the image data for each object (e.g., piece of equipment) on the rail vehicle to be inspected. In particular, the inspection component 62 can mask the image so that only the image data corresponding to the region of interest mask is segmented out. Additionally, using prior knowledge, the inspection component 62 can determine how many objects could be visible in the image data corresponding to the region of interest mask. For example, when locating a spring box on a rail vehicle, it is known that the spring box will be located between two rail wheels, both of which also may be visible in the image data corresponding to the region of interest mask.

In action A18, the inspection component 62 can invoke the deep learning engine 64 to identify one or more possible locations of image data corresponding to a region of interest for the object to be inspected. In an embodiment, the deep learning engine 64 can return each location as a boundary in the image data (e.g., a bounding box, object outline, and/or the like) with a corresponding confidence level for the boundary. In action A20, the inspection component 62 can determine whether the confidence level for a boundary is sufficient to perform the inspection. When the confidence level is sufficient, an automated inspection can proceed, otherwise human review will be required. To this extent, a threshold used for the confidence level to be sufficient can be selected using any solution and can affect an amount of manual involvement that will be necessary. In particular, when the threshold is set very high, a large percentage of images of objects will be presented to the expert 70 for review. When the threshold is set low, fewer images of objects will be presented to the expert 70. A suitable threshold can be set depending upon the confidence in the inspection system 12, a criticality of the object being inspected, an availability of an expert 70 to perform the review, and/or the like.

When the confidence level is sufficient, in action A22, the inspection component 62 can retrieve one or more reference images from the reference equipment database 48 for use in evaluating the object. For example, the inspection component 62 can use the vehicle identification information to look up reference images in the reference equipment database 48 for the object and retrieve a closest match to an image of the object in a known condition. When the particular rail vehicle and object have been previously inspected, the image could correspond to a previous image of the object being inspected. Otherwise, the image can be selected based on the type of the rail vehicle. In the latter case, multiple images can be returned corresponding to different possible valid configurations for the object.

In action A24, the inspection component 62 can determine a present condition of the object and corresponding inspection outcome (e.g., whether the object passes or fails) for the inspection. In particular, the inspection component 62 can compare the image data identified by the deep learning engine 64 with the reference image(s) to determine whether the image data is sufficiently similar. In an embodiment, the inspection component 62 can generate a metric of similarity based on the comparison. Such a metric of similarity can be generated using any of various techniques, such as normalized cross correlation, which the inspection component 62 can use to match the image data being evaluated with the image data in the reference image(s). When the metric of similarity exceeds a threshold for one or more images, the inspection component 62 can use data regarding a reference condition of the object in each of the one or more reference images to determine a present condition of the object and the corresponding inspection outcome for the inspection. For example, the inspection component 62 can calculate a weighted average of the reference conditions for each reference image exceeding a threshold.

In another embodiment, the inspection component 62 can provide the reference image(s) to the deep learning engine 64, which can be trained to evaluate the object condition and return an inspection outcome along with a corresponding confidence level in the inspection outcome. In this case, the deep learning engine 64 can be used for both object detection as well as object classification. In an embodiment, the deep learning engine 64 implements different deep learning models 66 to perform the object detection and object classification. The inspection component 62 can use the result returned by the deep learning engine 64 or can set a minimum confidence level in an inspection outcome (e.g., a good or bad evaluation) in order for the automated inspection to succeed. In the latter case, the inspection component 62 can use a default inspection outcome (e.g., pass or fail) when the threshold confidence level is not achieved. In either case, the inspection component 62 can generate an inspection outcome for the object as a result of the comparison(s) with the reference image data.

Regardless, depending on the object being inspected, the inspection component 62 and/or the deep learning engine 64 can perform a varying amount of analysis. For example, for some objects, the analysis can comprise a determination of whether the object is present (and appears secure) or absent. However, for other objects, an accurate measurement or estimate of one or more dimensions of the object may be required to determine an outcome for the inspection. To this extent, the inspection component 62 and/or the deep learning engine 64 can perform the analysis required to determine the inspection outcome for the object.

The process can include manual intervention. For example, when the inspection component 62 determines that the deep learning engine 64 failed to locate the object with sufficient confidence in action A20, the process can proceed to seek manual review. In an embodiment, the process also can seek manual review when the inspection component 62 determines that the object failed inspection in action A24 or the comparison did not result in a sufficient certainty with respect to the object's passing or failing the inspection. In this case, the expert 70 can confirm or deny the inspection result. In an embodiment, confirmation by the expert 70 varies based on the type of object being evaluated and/or a particular reason for the failure. For example, for a particular type of failure, such as a sliding wheel, the object failure can proceed directly to generating an alarm in order to ensure a real time response to detection of the error due to the danger inherent with such a condition.

In action A26, the inspection component 62 can present the image for review by an expert 70. For example, as discussed herein, the inspection component 62 can generate an interface 68, which can be presented to an expert 70 located at the inspection system 12 or remote from the inspection system 12. The expert 70 can use the interface 68 to, in action A28, manually identify or confirm a region of interest in the image data corresponding to the object and in action A30, manually determine an operating status of the object (e.g., good or bad). As illustrated, data regarding the region of interest identified by the expert 70 can be provided to the vehicle representation database 46 for use in future inspections.

Once an outcome of the inspection has been determined (e.g., either automatically, automatically with manual confirmation, or manually), in action A32, the inspection component 62 can determine the condition for the object, e.g., whether the object passed or failed. In an embodiment, if the object fails the inspection, in action A34 the inspection component 62 can generate a failed inspection alarm. The failed inspection alarm can be provided to an entity system 18 (FIG. 1), which is responsible for managing operations of the corresponding rail vehicle. The entity can initiate one or more actions in response to the alarm, such as scheduling maintenance, removing from service, halting or slowing a train, and/or the like.

When the object passes the inspection, in action A36, the inspection component 62 can add the image to the reference equipment database 48 as an example of a good object. While not shown, it is understood that the image for an object that failed inspection also can be added to the reference equipment database 48 as an example of a bad object. In an embodiment, only images that differ sufficiently from the closest images in the reference equipment database 48 are added. For example, an image that required manual review can be added, an image that resulted in a metric of similarity or confidence level below a certain threshold can be added, and/or the like. Additionally, it is understood that the inspection component 62 can provide an indication of a passed inspection to an entity system 18, e.g., to enable proper record-keeping of the inspection history for the object and/or corresponding rail vehicle. Such information also can provide, when determined, one or more measurements of the attributes of the inspected object. Such information can be used by the entity system 18 to track a rate of wear over time.

Regardless of the outcome of the inspection, in action A38, the inspection component 62 can add the image to the training database 49. As with the reference equipment database, the inspection component 62 can selectively add images to the training database 49, e.g., when manual review was required, a relatively low confidence level and/or metric of similarity were obtained, and/or the like.

As described herein, an embodiment of the invention uses a deep learning engine 64 and deep learning model 66 to perform one or more machine vision related tasks, including object detection and/or object classification. The deep learning engine 64 and deep learning model 66 can be built using any of various development platforms including: Tensor-Flow; PyTorch; MXNet (Apache); Caffe; MATLAB deep learning toolbox; Microsoft cognitive toolkit; etc. Deep learning solutions can have intense computational requirements, especially for training and testing the corresponding neural network.

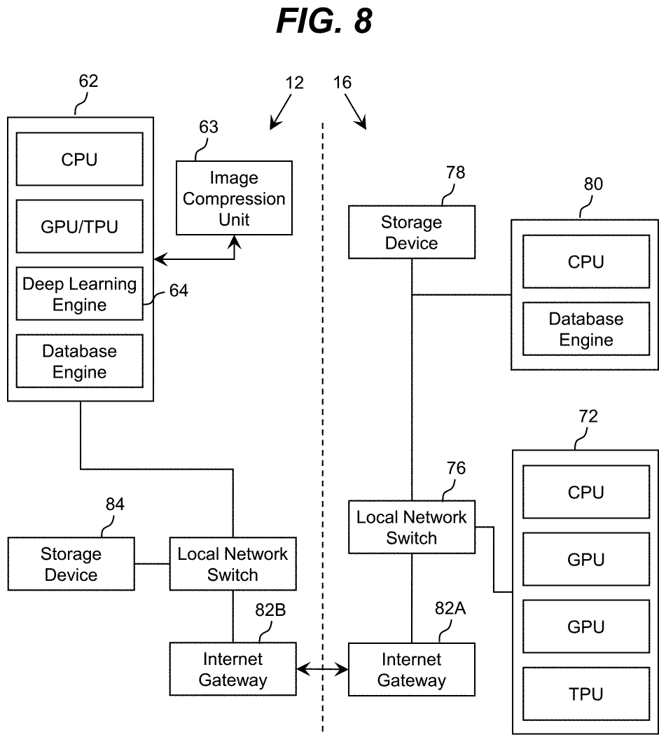

To this extent, FIG. 8 shows an illustrative hardware configuration for implementing deep learning in a solution described herein according to an embodiment. As illustrated, the deep learning training component 72 can be located remote from the inspection system 12. The deep learning training component 72 can include at least one central processing unit (CPU) and one or more graphics processing units (GPUs) and/or one or more tensor processing units (TPUs) in order to complete the training of the deep learning model. The use of one or more GPUs and/or one or more TPUs can significantly reduce the processing time (e.g., from days to hours). In an embodiment, the deep learning training component 72 can include a cluster of CPUs and GPUs for training. A CPU can comprise any general purpose multi-core CPU based on Intel, AMD, or ARM architectures, while a GPU can be any commercially available NVIDIA GPU, such as the Nvidia GTX 1080 or RTX 2080. The deep learning training component 72 can use multiple GPUs in conjunction with a high bandwidth switch 76 to create a computing cluster. However, it is understood that an embodiment of the deep learning training component 72 can comprise a pre-assembled server, such as Nvidia's DGX-1 server, or a server made by another vendor, e.g., Amax, Lambda Labs, etc.

Once a trained neural network model 66 (FIG. 3) is available, the neural network model 66 can be stored on a storage device 78 (e.g., a nonvolatile memory, such as a network attached storage) and subsequently deployed using a deployment server 80. As the computational requirements are significantly less, the deployment server 80 can include significantly less computing resources, e.g., a CPU, a database engine, and/or the like. The trained neural network model 66 can be communicated to the inspection system 12 via Internet gateways 82A, 82B, each of which can provide Internet connectivity for the corresponding system 12, 16 using a cable modem, cellular modem, and/or the like.

As illustrated, the inspection component 62 can perform the inspection process described herein, and can include a CPU and a GPU and/or TPU to accelerate vision and deep learning processes. Additionally, the inspection component 62 can implement the deep learning engine 64 and a database engine. The database engine can use any form of relational or non-relational database frameworks, such as SQL, MongoDB, AWS, and/or the like, to manage the vehicle representation database 46 (FIG. 3) and the reference equipment database 48 (FIG. 3), each of which can be stored in a on a storage device 84 (e.g., a nonvolatile memory, such as a network attached storage).

In an embodiment, the deep learning engine 64 can be implemented on hardware using a vision processing unit (VPU) computing architecture, such as Intel's Movidius architecture, which can accelerate computer vision processing. The VPU can be implemented separately (as shown in FIG. 3) or can be implemented as part of a generic host computing platform that also implements the inspection component 62 as shown in FIG. 7. For example, the VPU can comprise the main processing unit of the Neural Compute Stick, which can be added to any generic Intel/AMD/ARM based host computer. In this case, generic computer vision algorithms can be implemented by the CPU and/or GPU on the host computer, while the deep learning specific operations, such as an inference engine and neural network graphs, can be implemented on the deep learning engine 64.

The deep learning model 66 can be configured for execution on the deep learning engine 64 using any solution. For example, an embodiment can utilize the Intel Model Optimizer tool, which is a python based tool to import a trained neural network model from a popular framework such as Caffe, TensorFlow, MXNet, and/or the like. The Intel Model Optimizer tool is cross platform, and can be used to convert the neural network model from one of the above frameworks for execution on the Movidius platform. Such functionality can be useful to support the transfer learning process discussed herein. The model optimizer tool produces an intermediate representation, which represents the deep learning model 66. The process of applying the deep learning model 66 to a new image and generating results is called inference. The Intel inference engine can be used as a part of the deep learning engine 64 to use the intermediate representation and generate results for the new image.

An embodiment also can utilize the NVIDIA TensorRT tool, which is another useful deep learning engine that can be used for transfer learning and inference. TensorRT can execute up to 40× faster than CPU-only platforms during inference. TensorRT is built on CUDA, NVIDIA's parallel programming model, and can enable the deep learning engine 64 to optimize inference for all deep learning frameworks, leveraging libraries, development tools, and technologies in CUDA-X for artificial intelligence, autonomous machines, high-performance computing, and graphics. TensorRT can run on embedded GPUs, such as NVIDIA Jetson embedded platforms, which provide high portability and high inference throughput. NVIDIA Jetson Nano is capable of running deep learning models at approximately sixty frames per second. An embodiment can run with different GPU architectures either on GPU embedded devices or on GPU servers.

The inspection system 12 also can include an image compression unit 63, which can be used to compress image data prior to transmission to the remote system 16, e.g., for inclusion in the training database and/or presentation to an expert. In an embodiment, the image compression unit 63 comprises an ASIC, such as ADV202 produced by Analog Devices, which is engineered for JPEG 2000 compression. In another embodiment, the image compression unit 63 can comprise a custom FPGA-based solution for image compression. As discussed herein, an embodiment of the invention can only transmit the region of interest to the remote system 16 instead of the entire image for higher efficiency.

An embodiment of an inspection system described herein can assist in recognizing objects, inspecting parts, deducing measurements, qualifying parts for in-field use suitability, safety inspections, security related tasks, and reliability determination. In addition, an embodiment of the inspection system described herein can request human intervention to assist in recognizing objects, inspecting parts, deducing measurements, qualifying parts for in-field use suitability, and other difficult to process images, e.g., due to environment clutter, image capture challenges, and other typical challenges encountered in machine vision applications.

While shown and described herein as a method and system for inspecting one or more objects of an apparatus, it is understood that aspects of the invention further provide various alternative embodiments. For example, in one embodiment, the invention provides a computer program fixed in at least one computer-readable medium, which when executed, enables a computer system to inspect one or more objects of an apparatus using a process described herein. To this extent, the computer-readable medium includes program code, such as the inspection program 40 (FIG. 1), which enables a computer system to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as the inspection program 40 (FIG. 1), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for inspecting one or more objects of an apparatus. In this case, the generating can include configuring a computer system, such as the computer system 30 (FIG. 1), to implement a method of inspecting one or more objects of an apparatus as described herein. The configuring can include obtaining (e.g., creating, maintaining, purchasing, modifying, using, making available, etc.) one or more hardware components, with or without one or more software modules, and setting up the components and/or modules to implement a process described herein. To this extent, the configuring can include deploying one or more components to the computer system, which can comprise one or more of: (1) installing program code on a computing device; (2) adding one or more computing and/or I/O devices to the computer system; (3) incorporating and/or modifying the computer system to enable it to perform a process described herein; and/or the like.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1-16. (canceled)

17. An environment for inspecting an object of an identifiable apparatus, the environment comprising:
an inspection system including:
a deep learning engine configured to implement a deep learning model in order to analyze apparatus image data and identify object image data, wherein the object image data corresponds to a region of interest for the object of the apparatus in the apparatus image data; and
an inspection component for providing an inspection outcome for the object of the apparatus based on the object image data, wherein the inspection outcome for the object is determined by comparing the object image data with a set of reference equipment images related to the object.

18. The environment of claim 17, wherein the inspection component comprises at least two sub-components, the at least two sub-components including:
a pre-analysis inspection component for receiving the apparatus image data; and
a post-analysis inspection component for determining the inspection outcome for the object of the apparatus.

19. The environment of claim 17, wherein the inspection component further receives identification information for the apparatus, and wherein the inspection component obtains the set of reference equipment images using the identification information for the apparatus.

20. The environment of claim 19, wherein the inspection component further obtains representation data using the identification information for the apparatus, wherein the representation data includes information relating to the object for a type of the apparatus, and wherein the deep learning engine uses the representation data to identify the object image data.

21. The environment of claim 17, wherein the deep learning engine returns a confidence level associated with the object image data, and wherein the inspection component requests human assistance in response to the confidence level being below a predetermined threshold.

22. The environment of claim 21, wherein the inspection component receives second object image data in response to the human assistance request, wherein the second object image data is processed by the inspection component to determine the inspection outcome.

23. The environment of claim 22, wherein the inspection component stores the second object image data as a reference equipment image related to the apparatus.

24. The environment of claim 22, wherein the inspection component provides the second object image data, data indicating the inspection outcome for the object, and the apparatus image data, for inclusion in a training database for the deep learning engine.

25. The environment of claim 17, further comprising an acquisition system, the acquisition system including:
a plurality of sensing devices for acquiring data regarding the apparatus;
triggering logic configured to process the data regarding the apparatus to determine when to start and stop acquiring image data of the apparatus; and
a set of cameras configured to acquire the image data of the apparatus in response to a signal received from the triggering logic.

26. The environment of claim 25, wherein the acquisition system further includes at least one illuminator configured for operation in conjunction with at least one of the set of cameras.

27. The environment of claim 26, wherein the at least one illuminator is collocated with at least one of the set of cameras.

28. The environment of claim 25, wherein the inspection system further includes a data acquisition component for receiving data from the acquisition system and forwarding the apparatus image data for processing by the inspection component, and wherein the environment further comprises a high speed data connection between the set of cameras and the data acquisition component.

29. The environment of claim 17, wherein the inspection system includes an image compression unit comprising at least one central processing unit and at least one graphics processing unit, wherein the inspection component provides apparatus image data for compression by the image compression unit and transmits the compressed apparatus image data for storage in a training database for the deep learning engine.

30. The environment of claim 17, further comprising a training system including:
a deep learning training component for training the deep learning engine; and
a training database including image data for training the deep learning engine, wherein the inspection component transmits image data acquired during an inspection for storage in the training database, and wherein the deep learning training component periodically retrains a deep learning model using the training database and deploys an updated deep learning model for use in the inspection component.

31. An environment for inspecting an object of a rail vehicle, the environment comprising:
an inspection system including:
a deep learning engine configured to implement a deep learning model in order to analyze rail vehicle image data and identify object image data, wherein the object image data corresponds to a region of interest for the object of the rail vehicle in the rail vehicle image data; and
an inspection component for providing an inspection outcome for the object of the rail vehicle based on the object image data, wherein the inspection outcome for the object is determined by comparing the object image data with a set of reference equipment images related to the object.

32. The environment of claim 31, wherein the inspection component comprises at least two sub-components, the at least two sub-components including:
a pre-analysis inspection component for receiving the rail vehicle image data; and
a post-analysis inspection component for determining the inspection outcome for the object of the rail vehicle.

33. The environment of claim 31, wherein the deep learning engine returns a confidence level associated with the object image data, and wherein the inspection component requests human assistance to determine the inspection outcome in response to the confidence level being below a predetermined threshold.

34. The environment of claim 33, wherein the inspection component provides the second object image data, data indicating the inspection outcome for the object, and the rail vehicle image data, for inclusion in a training database for the deep learning engine.

35. A method of inspecting an object of an identifiable apparatus, the method comprising:
analyzing, using a deep learning model implemented on a deep learning engine, apparatus image data to identify object image data, wherein the object image data corresponds to a region of interest for the object of the apparatus in the apparatus image data;
obtaining a set of reference equipment images related to the object using identification information for the apparatus; and
determining an inspection outcome for the object by comparing the object image data with the set of reference equipment images related to the object, wherein the determining includes human assistance in response to the deep learning model indicating a confidence level associated with the object image data that is below a predetermined threshold.

36. The method of claim 35, wherein the apparatus is a rail vehicle.
